(19) United States
(12) Patent Application Publication
(10) Pub. No.: US 2018/0265388 A1
(43) Pub. Date: Sep. 20, 2018

(54) Systems And Methods For Treating Saltwater And Feedwater

(71) Applicant: Reverse Ionizer Systems, LLC, Bethesda, MD (US)

(72) Inventors: Desmond A. Fraser, Herndon, VA (US); Hossein Ghaffari Nik, Fairfax, VA (US); Richard B. McMurray, Fairfax, VA (US); Akrem Hassen Adem Aberra, Fairfax, VA (US); Shelley Marie Grandy, Ashburn, VA (US); Patrick J. Hughes, Vienna, VA (US)

(73) Assignee: Reverse Ionizer Systems, LLC, Bethesda, MD (US)

(21) Appl. No.: 15/919,568

(22) Filed: Mar. 13, 2018

Related U.S. Application Data
(60) Provisional application No. 62/471,314, filed on Mar. 14, 2017.

(51) Int. Cl. C02F 9/00

(52) U.S. Cl. CPC C02F 9/00; C02F 2209/40; C02F 1/487; C02F 2303/22; C02F 2303/08

(57) ABSTRACT

Feedwater and saltwater used in desalination plants, oil field installations, and large data centers can be treated to reduce scale, biological contaminants, and biologically induced corrosion therein by the integration of different treatment mechanisms.

### RELATED APPLICATIONS

This application is related to, and claims the benefit of priority from, U.S. Provisional Patent Application No. 62/471,314 (the '314 Application) filed Mar. 14, 2017.

Further, this application is related to U.S. Provisional Application No. 62/358,568 (“'568 Application”) filed Jul. 6, 2016, U.S. patent application Ser. No. 15/069,971 filed Mar. 15, 2016 (“'971 Application”), U.S. patent application Ser. No. 14/979,501 filed Dec. 27, 2015, (“'979 Application”), U.S. patent application Ser. No. 14/821,604 filed Aug. 7, 2015, (“'604 Application”), U.S. patent application Ser. No. 14/820,550 filed Aug. 6, 2015 (“'550 Application”), U.S. patent application Ser. No. 14/624,552 filed Feb. 17, 2015 (“'552 Application”), U.S. patent application Ser. No. 14/170,546 filed Jan. 31, 2014 (“'546 Application”) and U.S. Provisional Patent Application No. 61/759,345 filed Jan. 31, 2013 (“'345 Application”).

The present application incorporates by reference herein the entire disclosures of the '314, '568, '971, '979, '604, '550, '552, '546 and '345 Applications, including their text and drawings, as if set forth in their entirety herein.

### INTRODUCTION

Biological contaminants (bacteria, virus, and parasites) exchange genetic material via conjugation. The exchange of genetic material process is by tubular extension in the case of bacteria in which the membrane of one bacteria cell is extended to connect with the membrane of another bacteria cell. When the tubular extension connection is established bacteria of the same, and very different species and genres exchange genetic material between their cells—this process is considered promiscuous.

The exchange process means that resistant genes developed by one species of bacteria can rapidly spread to others and the entire bacteria community. Furthermore, it is a believed that many biological contaminants generate cell surface proteins that also bind heavy biocidal metal ions, producing a barrier that prevents the metal ions such as silver, copper, and zinc from entering the cell and denaturing the cell.

Thus, it is desirable to integrate different water treatment mechanisms making it far harder for bacteria populations to develop resistance in comparison with one mechanism.

### BRIEF DESCRIPTION OF THE DRAWINGS

FIG. 1 depicts a simplified block diagram of a system for treating saltwater and feedwater according to embodiments of the invention.

### SUMMARY

Systems, devices and related methods for treating saltwater and feedwater are provided.

In an embodiment, an exemplary system may comprise: an electrolytic ionization section operable to produce dissolved metal ions in the water, comprising at least one positively charged anode and at least one negatively charged cathode; an electro-magnetic section operable to generate and apply, time varying modulated electric and magnetic fields to the water to change the morphology of precipitated, salts within the water; and a plasma section operable to generate and apply plasma streamers to the dissolved metal ions in the water. In an embodiment, the electrolytic ionization section may comprise an ionization chamber configured to house the anode and cathode.

Exemplary anodes and cathodes may comprise arsenic, antimony, cadmium, chromium, copper, mercury, nickel, lead, antimony, silver, or zinc or compositions of arsenic, antimony, cadmium, chromium, copper, mercury, nickel, lead, antimony, silver, and zinc.

The exemplary system may further comprise a controller that is operable to control the magnitude of a direct current (DC) supplied to the electrolytic ionization section by a DC power supply and the flow rate of the water through the electrodes to control the amount of ionized dissolved metal ions in the water. The controller may be further operable to control a DC voltage and current output by the power supply and to determine a concentration of dissolved ions in the water.

In additional embodiments, an exemplary electro-magnetic section may be further operable to generate and apply the time varying modulated electric and magnetic fields at modulation frequencies that correspond to ionic cyclotron frequencies of such ions, where the modulation frequency(s) may comprise a frequency or frequencies in the range of 1.5 kHz-5 kHz.

The system as in claim 1 wherein the electro-magnetic section is further operable to generate and apply the time varying modulated electric and magnetic fields at a frequency above the circular wave guide cut-off frequencies of a piping system used in a desalination facility, industrial facility or data center, for example, wherein the waveguide cut-off frequency may be a frequency in a range selected from 900-928 MHz, 2.4-2.48 GHz, 5.7-5.8 GHz, 24 GHz, for example.

Still further, the electro-magnetic section may be operable to generate and propagate signals that include transverse electric and transverse magnetic dominant and higher order Bessel function modes.

The exemplary system may further comprise a meter operable to measure the flowrate of the water through the ionization chamber.

Yet further, the plasma section may be further operable to: (1) generate hydrogen ions in the water to treat scale by the generation and application of the plasma streamers to the water; (2) generate ozone in the water to treat biological contaminants and biologically induced corrosion treatment by the generation and application of the plasma streamers to the water; (3) generate nitrous oxide in the water to treat scale by the generation and application of the plasma streamers to the water, and/or (4) generate hydrogen peroxide to treat biological contaminants and biologically induced corrosion.

In addition to the systems described herein, the present invention also provides for related methods that correspond to each of the various, exemplary systems. For example, one exemplary method may comprise: producing dissolved metal ions in the water; generating and applying, time varying modulated electric and magnetic fields to the water to change the morphology of precipitated, salts within the water; and generating and applying plasma streamers to the dissolved metal ions in the water.

The exemplary method may further comprise controlling the magnitude of a direct current (DC) and the flow rate of the water to control the amount of ionized dissolved metal ions in the water.

Yet further, the exemplary method may comprise the generation and application of the time varying modulated electric and magnetic fields at modulation frequencies that correspond to ionic cyclotron frequencies of such ions, where the modulation frequencies comprise a frequency in the range of 1.5 kHz-5 kHz.

Still further, the exemplary method may comprise the generation and application of the time varying modulated electric and magnetic fields at a frequency above a circular waveguide cut-off frequencies of a piping system, where the waveguide cut-off frequency comprises a frequency in a range selected from 900-928 MHz, 2.4-2.48 GHz, 5.7-5.8 GHz, 24 GHz, and generating and propagating signals that include transverse electric and transverse magnetic dominant and higher order Bessel function modes.

An exemplary method may comprise measuring the flowrate of the water through the ionization chamber.

The present invention provides for additional, exemplary methods, including, but not limited to: (a) the generation of hydrogen ions in the water to treat scale, (b) the generation of ozone in the water to treat biological contaminants and biologically induced corrosion treatment, (c) the generation of nitrous oxide in the water to treat scale, and (d) the generation of hydrogen peroxide in the water to treat biological contaminants and biologically induced corrosion.

Though exemplary embodiments of systems, devices and related methods for treating saltwater and feedwater are described herein, and are shown by way of example in the drawings, it should be understood that there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

It should also be noted that one or more exemplary embodiments may be described as a process or method. Although a process/method may be described as sequential, it should be understood that such a process/method may be performed in parallel, concurrently or simultaneously. In addition, the order of each step within a process/method may be re-arranged.

A process/method may be terminated when completed, and may also include additional steps not included in a description of the process/method.

As used herein, the term “and/or” includes any and all combinations of one or more of the associated listed items. As used herein, the singular forms “a,” “an” and “the” are intended to include the plural form, unless the context and/or common sense indicates otherwise.

As used herein, the term “embodiment” or “exemplary” refers to an example of the present invention.

As used herein, the term “operable to” means “functions to”.

As used herein the phrase “unwanted material” includes all types of material, in dissolved or undissolved form which degrades or otherwise detracts from a desired quality of a liquid, such as saltwater or feedwater. One non-limiting example of unwanted material includes, but is not limited to, bacteria and/or scale.

As used herein the phrases “treat”, “treating,” “treatment” and other tenses of the word treat mean the inactivation, mitigation, reduction, removal, minimization, dissolution and elimination of unwanted material and the prevention of such unwanted material unless the context indicates otherwise to one skilled in the art.

As used herein the phrase “probe” means an element described herein that may be used to generate and apply one or more fields to water in order to treat the water that contains unwanted material, such as bacteria and/or scale.

It should be understood that when the description or drawings herein describe a “microcontroller”, “controller” or “computer” (collectively “controller”) that such a device includes stored, specialized instructions for completing associated, described features and functions, such as computations or the generation of control signals, for example. Such instructions may be stored in onboard memory or in separate memory devices. Such instructions are designed to integrate specialized functions and features into the controllers, and microcontrollers that are used to complete inventive functions, methods and processes related to treating saltwater and feedwater that contains unwanted material by controlling one or more inventive systems or devices/components used in such a treatment. Such instructions, and therefore functions and features, are executed by the controllers described herein at speeds that far exceed the speed of the human mind and, therefore, such features and functions could not be completed by the human mind in the time required to make the completion of such features and functions reasonable to those skilled in the art. Further, the inventors know of no existing prior art where the human mind has been used in place of the controllers to complete the features and functions described herein.

The following textual description and drawings may describe or include specific frequency, power and other values or information. It should be understood that such values and information is merely exemplary and non-limiting, it being understood that other values and information may be used without departing from the scope of the invention.

In accordance with an embodiment of the invention, a system that includes an electromagnetic assisted plasma probe with an electrolytic ionization section is provided. Operation of the system changes the morphology of precipitated scale, reduces the number of negative ions that otherwise will react with scaling ions present in desalination equipment, cooling towers and make-up water in general that have tendencies to form scale and ionizes metals with biocidal properties into dissolved ions to inactivate biological contaminants. The system functions to treat liquids (feedwater, saltwater, collectively “water”) through at least six mechanisms namely, ozone, hydrogen peroxide, high electric field, heat from plasma streamers, shock wave, and dissolved metal ions to inactivate biological contaminants.

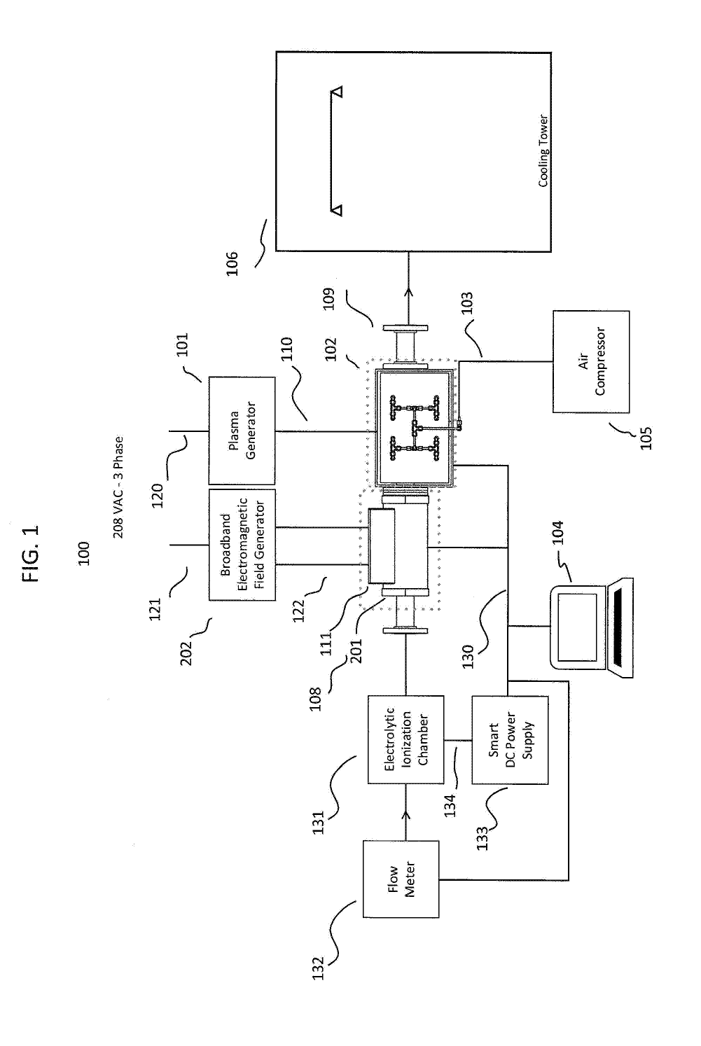

FIG. 1 depicts an illustrative system 100 according to an embodiment of the invention. As shown, the system 100 may have three sections: an electrolytic ionization section 131, an electro-magnetic section 111, 201, 202, and a plasma section 101, 102. Thus, at least three different mechanisms may be integrated to treat bacteria to prevent it from, among other things, developing resistance over time.

The electrolytic ionization section 131 may be positioned prior to the other two sections as shown, or after to name just two illustrative examples. Section 131 may consist of a positively charged anode and a negatively charged cathode (collectively “electrodes”). The electrodes can be made from any of the following metals and in any composition, arsenic, antimony, cadmium, chromium, copper, mercury, nickel, lead, antimony, silver, and zinc. In an embodiment, the electrolytic section may function to produce dissolved metal ions in the water. The amount of ionized dissolved metal ions from the electrolytic section is dependent on the magnitude of the DC current supplied to section 131 and the flow rate of the water through the electrodes.

The electro-magnetic section 11, 201, 202 may function to generate and simultaneously apply, for example, time varying modulated electric and magnetic fields, perpendicular to each other. The fields generated by section 11, 201,202 function to treat and, or mitigate scale such as calcium carbonate, calcium sulfate, magnesium carbonate, and silica, biological contaminants, (biofilm, Legionella bacteria, viruses, parasites, etc.), and biologically induced corrosion in desalination plants, oil field installations, and large data centers feed water, to name just a few applications.

The electro-magnetic section 11, 201, 202 may function to generate signals and apply fields to the water that changes the morphology of the precipitation of supersaturated salts within the water fed to desalination plants, oil field installations, and or large data centers' circular or rectangular cooling tower piping systems so that the salts do not adhere to the pipe walls and heat exchangers. The signals and fields generated and applied by section 11, 201, 202 treat scaling ions in water using modulation frequencies that correspond to the ionic cyclotron frequencies of such ions to keep the precipitated scale soluble and prevent it from forming hard needle-like crystalline scale that covers the surface of the membranes and clog pipes.

Furthermore, section 11, 201, 202 may function to generate signals and fields having corresponding carrier frequencies above the circular wave guide cut-off frequencies of a piping system as follows:

f_{c}=1.8412/C*2*n*r

Where f_{c}=the carrier operating frequency, and r=the radius of the circular distillation or system piping.

Because the exemplary section 11, 201, 202 may function to generate signals above the waveguide cut-off frequencies (for example, 900-928 MHz, 2.4-2.48 GHz, 5.7-5.8 GHz, 24 GHz, etc.) of circular or rectangular piping systems, the system 100 may be operable to generate and propagate signals that include TE (Transverse Electric) and TM (Transverse Magnetic) dominant and higher order Bessel function modes (for example, but not limited to TE₀₁, TE₀₂, TE₀₃, TE₁₁, TM₁₂, TE₂₁, TE₂₃, TE₃₁, TE₄₁, TE₅₁, TE₆₁, TE₈₁, TM₀₁i, TM₀₂, TM₀₃,TM₁₁, TM₁₂, TM₁₃, TM₂₁, TM₂₂, TM₃₁, TM₃₂, TM₅₁, TM₆₁, etc.) to treat scaling ions within very long pipes.

In an embodiment, the RF power attenuation losses associated with the system 100 may be on the order of approximately 1 dB/100 meters to 2 dB/100 meters within circular or rectangular piping systems resulting from operating above the waveguide cut-off frequency

Also, the TE and TM dominant and higher order Bessel function modes achieve higher efficiencies in long pipe system installations than would otherwise be possible operating with a single mode operating frequency in circular or rectangular piping systems.

The system 100 reduces the precipitation of supersaturated salts within water by generating modulation signals that target (i.e., use) the ionic cyclotron frequencies of the scaling ions to keep them soluble and from precipitating into a hard needle-like crystalline form of various types of scale that reduces the pressure on the surface of the membrane and or pipes.

The plasma section 101, 102 may function to generate non-thermal plasma micro-discharge filaments, hereafter, referred to as “plasma streamers” or “streamers” in combination with dissolved metal ions containing biocidal properties.

In more detail, the electrolytic ionization section 131 may comprise an ionization chamber that houses the electrodes and through which the water flows, and a DC power supply 133 that can provide a variable DC voltage and current. In an embodiment a microprocessor, microcontroller or controller 104 (collectively “controller”) may function to control the DC voltage and current output by the supply 133 which is supplied to the electrodes.

A meter 132 functions to measure the flowrate of water through the ionization chamber 131 in order, in conjunction with the controller 104 for example, to determine the concentration of dissolved ions in the water.

The electro-magnetic section 11, 201, 202 may function to generate a simultaneously applied, for example, time varying modulated electric and magnetic field, perpendicular to each other, that assists in the treatment and or mitigation of scale, biological contaminants, (biofilm, Legionella bacteria, etc.), and biologically induced corrosion.

The simultaneously applied time varying modulated electric and magnetic fields are believed to cause scaling ions in the water to simultaneously accelerate (i.e., speed up) and vibrate or otherwise move in a spiral, helical or cycloid motion. The net result is that the scaling ions remain soluble in the water prior to entering the plasma section 101,102 (when so configured), where reactive and molecular species are produced to further treat and or mitigate scale, biological contaminants, (biofilm, Legionella bacteria, etc.), and biologically induced corrosion.

As mentioned previously, the time varying modulated electric fields generated and applied to the water by the section 11, 201, 202 may also function to prevent and or eliminate biological contamination in the water by applying a 1.5 kHz-5 kHz modulated square wave pulse, for example, that effectively denatures biofilm and biological contaminants. Additionally, the time varying modulated magnetic fields generated by section 11, 201, 202 may also prevent and or eliminate corrosion in the water when such fields correspond to a signal at an ionic cyclotron frequency of iron (Fe).

Section 101,102 may function to generate plasma streamers in the water that initiates energetic electrons, and space charge accumulation, which produces reactive (ionic and excited atomic) species and molecular species in the water. These reactive and molecular species may be characterized by electron avalanche, rotational and gravitational excitation, dissociation, and ionization processes and have exemplary energies up to 20 electron Volts (eV).

For example, the application of plasma streamers to the water may function to initiate exemplary rotational and vibrational excitation of the water below 1 eV energy threshold, and function to initiate exemplary electron avalanche, producing various charged particles (electrons, positive ions, negative ions, complex ions, etc.) between 5 eV to 20 eV energy thresholds. In addition, the application of plasma streamers to the water may function to initiate the disassociation of reactive and molecular species of water between 8 eV and 9 eV, and ionization of the water at an exemplary threshold of approximately 13 to 14 eV.

The application of plasma streamers to the water that functions to initiate rotational and vibrational excitation, electron avalanche, dissociation, and ionization processes may further function to initiate chemical reactions that involve, or produce, hydroxyl (OH), hydrogen (H), oxygen (O), hydrogen peroxide (H₂O₂), hydronium (H₃O), super oxide anion (′O₂—), singlet oxygen (¹O₂) ions, ozone (O₃) and ultra violet light.

Scale formation occurs in desalination plants, oil field installations, and large data centers when highly soluble and naturally occurring calcium ions (Ca²⁺) and bicarbonate (HCO₃) ions precipitate into calcium carbonate (CaCO₃) and carbon dioxide (CO₂) gas as a result of temperature, pressure and pH changes in the saltwater or feed water.

As noted previously, the plasma section 101, 102 may function to treat and or mitigate scale, biological contaminants, (Biofilm, Legionella bacteria, etc.), and biologically induced corrosion. Below, we discuss some exemplary processes in more detail.

Process 1, Scale Treatment Through Hydrogen Ion Generation:

The plasma section 101,102 may be configured to treat scale through ionization of the water by producing plasma streamers that create hydrogen ions which in turn react to remove bicarbonate ions. From equation (1) below, positive ions may attach to the molecules of water to produce oxoniumyl (H₂O⁺). Oxoniumyl (H₂O⁺) may further attach to water molecules to produce hydronium (H₃O⁺) and hydroxyl (OH).

Hydrogen (H) ions may be produced by direct ionization of the water molecules as a result of the generation of plasma streamers in the water by section 101,102. The hydrogen ions react with bicarbonate ions (HCO₃) present in water to produce additional water (H₂O) and carbon dioxide gas (CO₂), as illustrated by equation (3) below.

H₂O⁺+H₂O→H₂O⁺+OH (1)

H₂O⁺+H₂O→H₃)⁺−OH (2)

H⁻+HCO₃³¹ →H₂O⁺+CO₂↑ (3)

Thus, by removing bicarbonate ions from the water, the plasma section 101,102 may function to eliminate the propensity for scale to form on heat exchanger elements and the inside of pipe walls.

Process 2, Biological Contaminants and Biologically Induced Corrosion Treatment Through Ozone Generation:

In another embodiment, the plasma streamers produced by the plasma section 101,102 may function to treat biological contaminants, (Biofilm, Legionella bacteria, etc.) and biologically induced corrosion in saltwater or feed water with ozone. The plasma streamers function to produce ozone (O₃) gas by electron impact dissociation of molecular oxygen (O₂) and molecular nitrogen (N₂) of the carrier gas entering section 101,102 via compressor 105, for example. The plasma streamers may function to produce ozone from the carrier gas, which can be ambient air or dry air, in which the molecular oxygen (O₂) gas reacts with an oxygen atom from the carrier gas. The ozone gas, produced to treat biological contaminants and biologically induced corrosion, may dissolve into the water.

Process 3, Scale Treatment Through Nitric Oxide Generation:

In yet another embodiment, the plasma section 101,102 may function to treat scale by generating plasma streamers that ionizes the water through the production of hydrogen through the disassociation of nitric acid (HNO₃) which then disassociate to hydrogen (H+) ions and nitrate (NO₃) ions to remove bicarbonate ions. The carrier gas from compressor 105, for example, may enter plasma probe 102 and come in contact with the water where it is ionized and disassociated to molecular nitrogen (N₂) gas and molecular oxygen (O₂) gas. Both molecular nitrogen (N₂) gas and molecular (O₂) gas further reacts with nitrogen atoms and oxygen atoms to produce nitric oxide (NO_{X}) gas. The oxygen atom from the carrier gas oxidizes nitrate (NOₓ) to nitrogen dioxide (NO₂). The nitrogen dioxide (NO₂) in saltwater or feed water result in nitric acid (HNO₃). Nitric acid (HNO₃) is then disassociated to hydrogen (H⁺) ions and nitrate (NO₃) ions. The hydrogen ions produced from Nitric acid contributes further to the removal of bicarbonate ions to treat and or mitigate scale.

Process 4, Biological Contaminants and Biologically Induced Corrosion Treatment Through Hydrogen Peroxide Generation:

Another illustrative plasma section 101,102 may function to treat biological contaminants, (biofilm, Legionella bacteria, etc.) and biologically induced corrosion in the water with hydrogen peroxide. Plasma streamers produced by section 101,102 create hydrogen peroxide through electron impacts. This may be initiated by the disassociation of vibrational excited molecules, whereby excited water (H₂O*) molecules decompose (see equation (6) below). The excited water molecules (H₂O*) react with water (H₂0) molecules to produce hydrogen ions (H), hydroxyl ions (OH), and additional water (H₂O). The reaction illustrated by Equation (7) below further propagates additional reactions of vibrationally excited molecules (illustrated by Equations (8) and (9) below) to produce hydrogen peroxide H₂O₂.

H2O+e→H2O*−e (4)

H2O*+H2O→H+OH+H2O (5)

H+H2O*→H2+HO (6)

OH+H2O*→H2O2+H (7)

N₂+O_{2 Plasma}→NO_{X} (8)

NO_{X}+H₂O→HNO₃+H⁺+NO₃⁻ (9)

We claim:

1. A system for treating saltwater and feedwater (water) comprising:
an electrolytic ionization section operable to produce dissolved metal ions in the water, comprising at least one positively charged anode and at least one negatively charged cathode;
an electro-magnetic section operable to generate and apply, time varying modulated electric and magnetic fields to the water to change the morphology of precipitated, salts within the water; and
a plasma section operable to generate and apply plasma streamers to the dissolved metal ions in the water.

2. The system as in claim 1 wherein the anode and cathode comprise arsenic, antimony, cadmium, chromium, copper, mercury, nickel, lead, antimony, silver, or zinc or compositions of arsenic, antimony, cadmium, chromium, copper, mercury, nickel, lead, antimony, silver, and zinc.

3. The system as in claim 1 further comprising a controller operable to control the magnitude of a direct current (DC) supplied to the electrolytic ionization section by a DC power supply and the flow rate of the water through the electrodes to control the amount of ionized dissolved metal ions in the water.

4. The system as in claim 3 wherein the controller is further operable to control a DC voltage and current output by the power supply and to determine a concentration of dissolved ions in the water.

5. The system as in claim 1 wherein the electro-magnetic section is further operable to generate and apply the time varying modulated electric and magnetic fields at modulation frequencies that correspond to ionic cyclotron frequencies of such ions.

6. The system as in claim 4 wherein the modulation frequencies comprise a frequency in the range of 1.5 kHz-5 kHz.

7. The system as in claim 1 wherein the electro-magnetic section is further operable to generate and apply the time varying modulated electric and magnetic fields at a frequency above the circular wave guide cut-off frequencies of a piping system.

8. The system as in claim 5 wherein the waveguide cut-off frequency comprises a frequency in a range selected from: 900-928 MHz, 2.4-2.48 GHz, 5.7-5.8 GHz, 24 GHz.

9. The system as in claim 1 wherein the electro-magnetic section is further operable to generate and propagate signals that include transverse electric and transverse magnetic dominant and higher order Bessel function modes.

10. The system as in claim 1 wherein the electrolytic ionization section comprises an ionization chamber configured to house the anode and cathode.

11. The system as in claim 10 further comprising a meter operable to measure the flowrate of the water through the ionization chamber.

12. The system as in claim 1 wherein the plasma section is further operable to generate hydrogen ions in the water to treat scale by the generation and application of the plasma streamers to the water.

13. The system as in claim 1 wherein the plasma section is further operable to generate ozone in the water to treat biological contaminants and biologically induced corrosion treatment by the generation and application of the plasma streamers to the water.

14. The system as in claim 1 wherein the plasma section is further operable to generate nitrous oxide in the water to treat scale by the generation and application of the plasma streamers to the water.

15. The system as in claim 1 wherein the plasma section is further operable to generate hydrogen peroxide to treat biological contaminants and biologically induced corrosion.

16. A method for treating saltwater and feedwater (water) comprising:
producing dissolved metal ions in the water;
generating and applying, time varying modulated electric and magnetic fields to the water to change the morphology of precipitated, salts within the water; and
generating and applying plasma streamers to the dissolved metal ions in the water.

17. The method as in claim 16 further comprising controlling the magnitude of a direct current (DC) and the flow rate of the water to control the amount of ionized dissolved metal ions in the water.

18. The method as in claim 16 further comprising generating and applying the time varying modulated electric and magnetic fields at modulation frequencies that correspond to ionic cyclotron frequencies of such ions, where the modulation frequencies comprise a frequency in the range of 1.5 kHz-5 kHz.

19. The methods as in claim 16 further comprising generating and applying the time varying modulated electric and magnetic fields at a frequency above a circular waveguide cut-off frequencies of a piping system, where the waveguide cut-off frequency comprises a frequency in a range selected from: 900-928 MHz, 2.4-2.48 GHz, 5.7-5.8 GHz, 24 GHz, and generating and propagating signals that include transverse electric and transverse magnetic dominant and higher order Bessel function modes.

20. The method as in claim 16 further comprising measuring the flowrate of the water through the ionization chamber.

21. The system as in claim 16 comprising generating hydrogen ions in the water to treat scale.

22. The method as in claim 16 further comprising generating ozone in the water to treat biological contaminants and biologically induced corrosion treatment.

23. The method as in claim 16 further comprising generating nitrous oxide in the water to treat scale.

24. The method as in claim 16 further comprising generating hydrogen peroxide in the water to treat biological contaminants and biologically induced corrosion.
